(19) United States
(12) Patent Application Publication
(10) Pub. No.: US 2009/0052279 A1
(43) Pub. Date: Feb. 26, 2009

(54) METHOD AND SYSTEM FOR DETERMINING AZIMUTH PARAMETERS FOR SEISMIC DATA PROCESSING

(76) Inventors: Charles Sicking, Plano, TX (US); E. Stuart Nelan, Melissa, TX (US); William H. McLain, Bend, OR (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 11/842,339

(22) Filed: Aug. 21, 2007

(51) Int. Cl. G01V 1/28

(52) U.S. Cl. 367/47; 702/14

(57) ABSTRACT

A method and system determines optimum azimuth parameters for seismic data processing. The method includes selecting a range of azimuth parameters, the azimuth parameters indicating the range of magnitudes and directions, each pair of azimuth parameters indicating a particular magnitude and a particular direction. The method further includes generating a plurality of seismic gathers wherein a seismic gather is generated from each pair of azimuth parameters, each seismic gather including a plurality of seismic data traces. The method further includes generating a plurality of seismic gathers for a plurality of imaging locations and a plurality of depths, each seismic gather containing a plurality of seismic data traces. The method further includes determining the coherence amplitude of each gather. The method further includes determining the gather having the optimum coherence amplitude, and selecting the azimuth parameters associated with the gather having the optimum coherence amplitude.

### BACKGROUND OF THE INVENTION

The invention relates to seismic data processing. More specifically, the invention relates to a method and system for determining azimuth parameters from velocity anisotropy in the earth's subsurface.

### DESCRIPTION OF RELATED ART

Seismic data processing is performed by transmitting seismic signals into the Earth's subsurface and detecting the reflected signals. The seismic signals are transmitted by sources such as dynamite, impulse, vibrator or any other type of sources that impart seismic energy into the earth's subsurface. The reflected signals are received by receivers such as geophones or any other type of receivers capable of receiving reflected energy from the earth's subsurface.

The delay time between the transmission of the seismic signal at a source location and the detection of the reflected signal at a receiver location indicates the depth of geological interfaces. Since the geological interfaces often indicate possible existence of oil and gas reservoirs in the earth's subsurface, accurate determination of the reflection depth is crucial in seismic data processing.

Accurate determination of the reflection depth depends on the correct estimation of subsurface velocities of the propagating seismic signal. A commonly used technique to estimate the subsurface velocity of the seismic signal is to measure the difference in the travel time of a particular seismic signal between one receiver and another. A good estimation of the subsurface velocity is generally indicated if the travel time increases proportionally with distance between the source and each successive receiver.

In the past, seismic data was processed using an azimuthally isotropic model, which assumed that the velocity of seismic signals does not vary with azimuthal variations. It was of course understood that in reality the velocity of the seismic waves indeed varied with azimuthal variations. Recent improvements in three-dimensional (3D) seismic data processing technology have allowed the incorporation of azimuthal variations in the seismic velocity into seismic data processing algorithms. Various methods have been proposed for incorporating azimuthal variations in the velocity into the seismic data processing algorithm.

The parameters for azimuthal variation in velocity are the direction of variation and the magnitude of variation. The direction and magnitude of variation in velocity can change throughout the earth volume.

FIG. 1 illustrates an array of seismic sources and receivers on the surface of the earth. The seismic sources and receivers are positioned for the acquisition of three-dimensional seismic data. Seismic signals are transmitted by the seismic sources into the earth's subsurface and the reflected signals are detected by the seismic receivers. As discussed before, the delay time between the transmission of the seismic signal and the detection of the reflected signal indicates the depth of geological interfaces.

As shown in FIG. 1, seismic sources S1, S2 and S3 transmit seismic signals into the earth along an east-west axis through a common mid point 0. Reflected signals are received at seismic receivers R1, R2 and R3, respectively, along the east-west axis. Seismic sources S4, S5 and S6 transmit seismic signals into the earth along a north-south axis through the common mid point 0. Reflected signals are received by seismic receivers R4, R5 and R6 along the north-south axis. The north-south and east-west axis are shown for illustrative purposes. The seismic sources and receivers may be any number of arrays that yields a three-dimensional seismic data, and the azimuths may be at any angles. As will be understood by those skilled in the art, the travel time of a seismic signal from a seismic source to a seismic receiver is represented by the following equation:

T²=T₀²+r²/v²

Where T is the travel time between the source and the receiver, T₀ is the travel time when the source and receiver are at the same point, r is the distance between the source and the receiver (i.e., source-receiver offset), and v is the normal velocity.

FIG. 2 illustrates the travel times as a function of the distance in an azimuthally anisotropic subsurface for east-west and north-south trace azimuths through the common midpoint 0 for the source-receiver sets shown in FIG. 1. Due to the azimuthal anisotropy, the velocity changes as a function of the direction and degree of anisotropy. Consequently, the travel time for the east-west axis differ from the travel time for the north-south axis.

Generally, seismic data processing algorithms require that the direction and magnitude of the azimuth variations in the velocity be specified for each point in the earth's three-dimensional volume. An example of the direction and magnitude of the azimuthal variations in the velocity at a particular point is 30 degrees East of North and 4 percent increase in velocity as compared to a reference velocity at that point. The derivation of the azimuth parameters depends on having a reference velocity that is computed using azimuthal isotropic analysis. The magnitude parameter for azimuth variation is specified as a percent of the reference velocity.

According to current methods, the azimuth parameters (i.e., direction and magnitude) are derived from multiple seismic data traces having a common mid point (CMP) gather. A CMP gather is a collection of seismic data traces wherein the midpoint between the source location and the receiver location for each trace lies at the same location. One such current method is described in patent U.S. Pat. No. 6,898,147. However, the signal to noise ratio in CMP gathers can be unacceptably high. Consequently, in this approach to azimuthal analysis, only a few seismic data traces are summed prior to the analysis. The summing is limited to only a few data traces to avoid distorting the signal.

### SUMMARY OF THE INVENTION

A method for determining optimum azimuth parameters for seismic data processing includes selecting a range of azimuth parameters. The azimuth parameters indicate the range of magnitudes and directions, each pair of azimuth parameters indicating a magnitude and a direction. The method includes generating a plurality of seismic gathers wherein a seismic gather is generated for each pair of azimuth parameters. Each seismic gather includes a plurality of seismic data traces. The method includes generating a plurality of seismic gathers for a plurality of imaging locations and a plurality of depths. The method includes determining the coherence amplitude of each gather and determining the gather having the optimum coherence amplitude. The method includes selecting the azimuth parameters associated with the gather having the optimum coherence amplitude.

The optimum coherence amplitude is determined by determining the highest coherence amplitude and designating the highest coherence amplitude as the optimum coherence amplitude.

The method further includes plotting the coherence amplitude of the gathers and identifying the optimum gather by determining the gather having the maximum coherence amplitude over an analysis window. The method further includes selecting the azimuth parameters associated with the optimum gather and identifying the selected azimuth parameters as the optimum azimuth parameters.

### BRIEF DESCRIPTION OF THE DRAWINGS

FIG. 1 illustrates an array of seismic sources and receivers on the surface of the earth.

FIG. 2 illustrates travel times in an azimuthally anisotropic subsurface.

FIGS. 3A and 3B illustrate a comparison of a gather of seismic data traces without prestack imaging to a gather of seismic data traces with prestack imaging.

FIG. 4 shows a typical gather of seismic data traces generated using azimuth parameters.

FIG. 5 is a table of an exemplary range of magnitude and direction parameters.

FIG. 6 shows the analysis of the gathers.

FIG. 7A shows a map view of a surface constructed using the coherence amplitude values, and FIG. 7B shows a three-dimensional perspective view.

FIG. 8 shows an exemplary computer system 900 configured to execute the seismic data processing steps described above.

FIG. 9 shows a computer system configured to execute the seismic data processing steps in accordance with one embodiment of the invention.

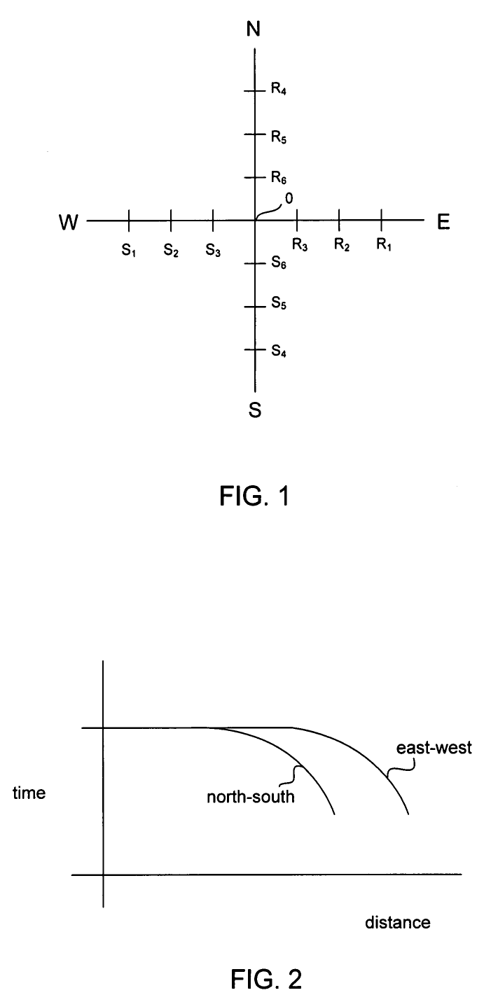

### DETAILED DESCRIPTION OF THE EMBODIMENTS

In one embodiment, a predetermined number of seismic data traces are coherently combined to determine the azimuth parameters. The coherent combination algorithm is a seismic imaging method that compensates for phase and amplitude variation of each signal as a function of the wave propagation path. This allows combining of tens of thousands of seismic data traces. By applying imaging on the CMP gathers and then performing the azimuthal analysis on the resulting gathers, the signal to noise ratio is improved as compared to the azimuthal analysis carried out on the CMP gathers without applying imaging.

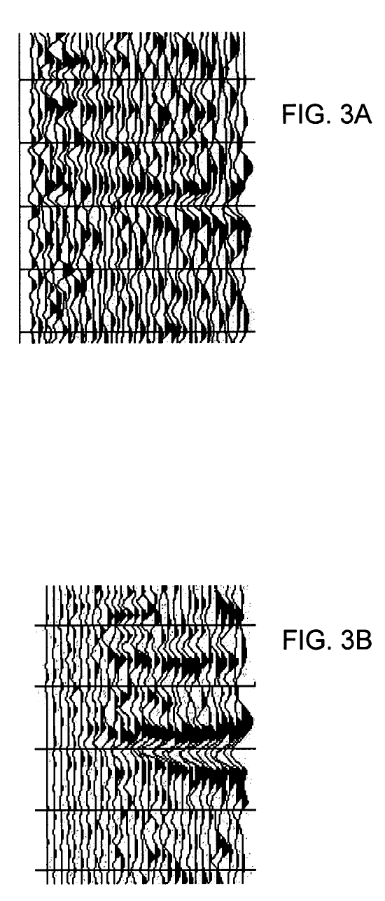

FIGS. 3A and 3B illustrate a comparison of a gather of seismic data traces without prestack imaging to a gather of seismic data traces with prestack imaging. The two gathers are at the same map location. The signal to noise ratio of the gather with prestack imaging (FIG. 3B) is significantly better than the signal to noise ratio of the gather without prestack imaging (FIG. 3A). Prestack imaging is carried out to produce gathers such as those shown in FIG. 3B. The azimuthal analysis is then carried out on the imaged gathers. Presently, azimuthal analysis is carried out on the gather before imaging such as those shown in FIG. 3A.

In one embodiment, a method for determining the azimuth parameters includes multiple application of imaging for a range of directions and a range of magnitudes. As discussed before, the application of imaging refers to a combination of a set of traces which were collected by transmission of seismic signals from seismic sources into the Earth's subsurface and detection of the reflected signals by seismic receivers as discussed before. For each set of azimuth parameters, direction and magnitude (i.e., pair of parameters), one gather of seismic data traces is generated. A single gather includes a collection of seismic data traces from a single map location. Each seismic data trace in the gather is generated from a different source and receiver pair that have the same offset distance between the source and receiver. Thus, each seismic data trace in the gather reflects the travel time of a seismic signal that has propagated a distance based on the particular source-receiver distance (also referred to as source-receiver offset). The number of seismic data traces in a gather can typically range from 20 to 60.

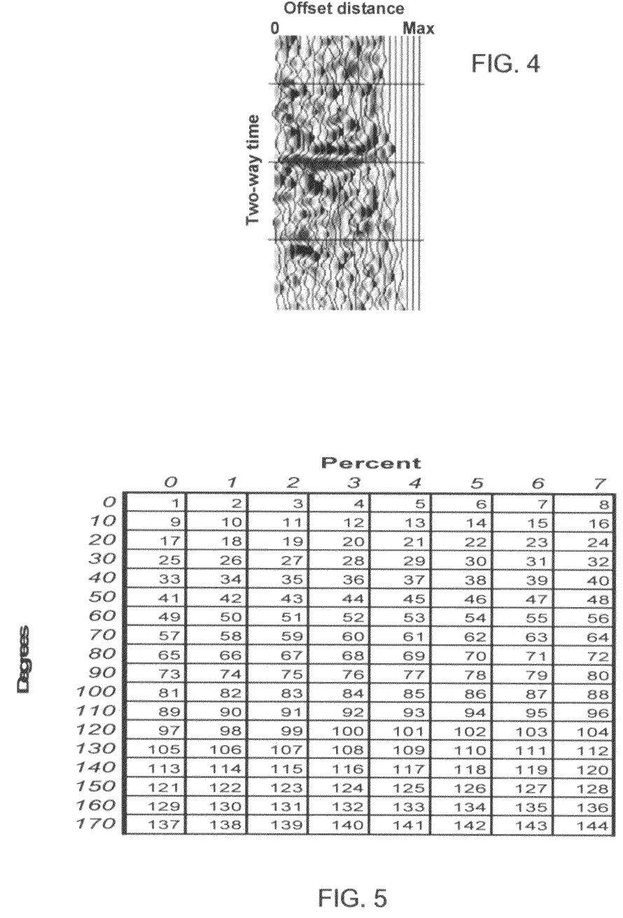

FIG. 4 shows a typical gather of seismic data trace generated using azimuth parameters. A range of azimuth parameters is selected to generate a plurality of gathers. For example, a typical range of azimuth parameters is 0 to 7 percent in magnitude with a step of 1 percent and 0 to 180 degrees with a step of 10 degrees. For this exemplary range of azimuth parameters, 144 gathers of seismic data trace are generated at each point in a map location. For each pair of azimuth parameters, a single gather is generated.

FIG. 5 is a table of an exemplary range of magnitude and direction parameters. Since there are 8 magnitudes (percentage) and 18 directions (degree), a total of 144 gathers is generated. These 144 gathers are analyzed, and the gather having the maximum coherence amplitude is selected as the optimum gather. The process is repeated at each imaging location and for each depth.

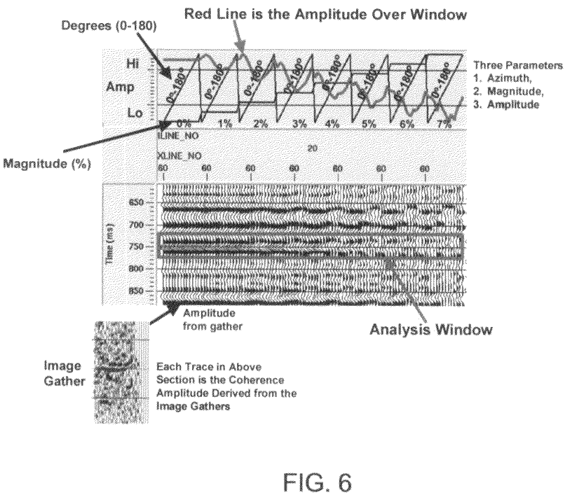

FIG. 6 shows the analysis of the gathers. The coherency amplitude of each gather is determined by combining all the seismic data traces in the gather. The coherency amplitude is computed over the time window shown in the trace display on the bottom section of FIG. 6 and outlined by the red box. Each trace in the red box in FIG. 6 is computed from a gather produced by the imaging process. An example gather is shown at the bottom of FIG. 6. The coherency amplitude for each of the traces shown in the section is plotted in the red line at the top of FIG. 6. In computing the coherency amplitude, the traces can be combined using semblance, stack, stack power or other coherence amplitude methodologies. Semblance is a measure of multichannel coherence and is the ratio of the energy of the input samples to the energy of the output sample. Stack is the sum of the traces in the gather at each time sample. Stack power is the sum of the traces in the gather at each time sample followed by the computation of square to form the power at each time sample on the trace.

Next, the optimum gather is determined. In one embodiment as shown in FIG. 6, the gather having the maximum coherence amplitude over an analysis window is selected as the optimum gather. The analysis window used for the coherency analysis is an input parameter. Normally the window is specified either by a specified two-way time or by a horizon picked by the user. The analysis window shown in FIG. 6 is selected to cover the time window of the horizon under investigation. The azimuth direction and magnitude parameters and the coherence amplitude for the specified window are plotted at the top of the display. The largest coherence amplitude over the analysis widow is selected, and the azimuth parameters for this coherence amplitude are chosen as the optimum set of azimuth parameters.

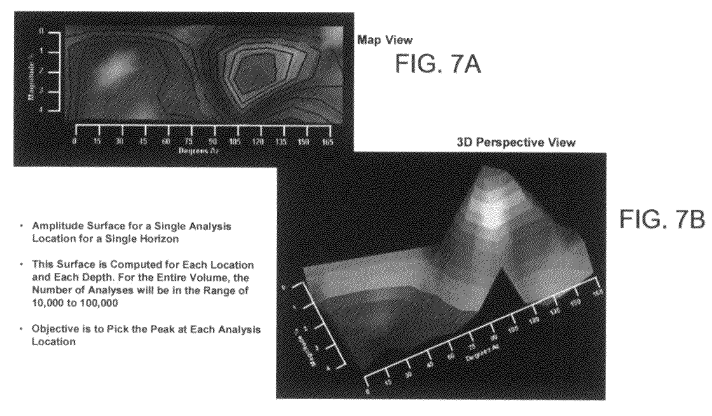

FIG. 7A shows a map view of a surface constructed using the coherence amplitude values for each trace. The plot in FIG. 7A represents the analysis for a single location and single depth in the volume under investigation. As shown in FIG. 7A, the axes are the azimuth parameters, i.e., direction and magnitude. The analysis is repeated for many locations and at all many depths in the earth volume under investigation. For a selected volume, the number of analyses can range from 10,000 to 100,000. FIG. 7B shows a three-dimensional perspective view of the plot in FIG. 7B. The location of the peak in FIG. 7B is identified and its corresponding direction and magnitude is chosen as the optimum set of azimuth parameters for a single point in the volume. Thus, by repeating the analysis at many map locations and at many depths, a volume of azimuth parameters is constructed. These azimuth parameters are the optimum parameters for each point in the earth volume under investigation.

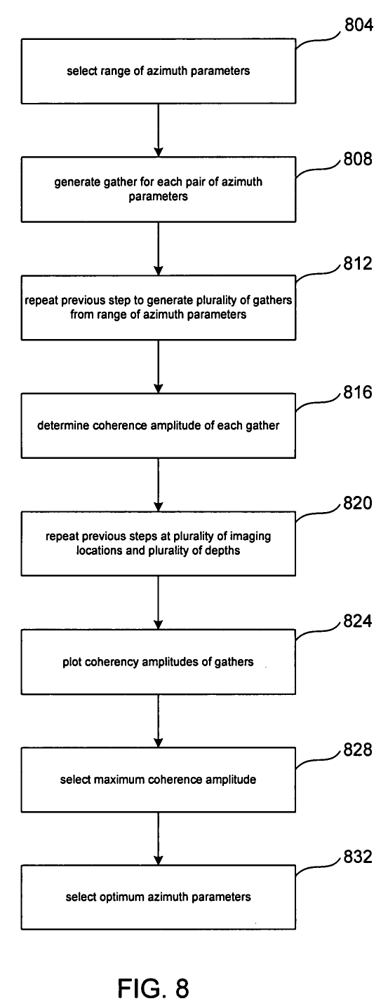

FIG. 8 is a flow diagram of the steps of determining the azimuth parameters in accordance with one embodiment. In step 804, a range of azimuth parameters is chosen. For example, a typical range of azimuth parameters is 0 to 7 percent in magnitude with a step of 1 percent and 0 to 180 degrees with a step of 10 degrees.

In step 808, for each pair of azimuth parameters, a single gather is generated. In step 812, the previous step (step 808) is repeated so that a plurality of gathers are generated using the selected range of azimuth parameters. For this exemplary range of azimuth parameters, 144 gathers of seismic data trace are generated at each point in a map location.

In step 816, the coherency amplitude of each gather is determined by combining all the seismic data traces in the gather. The coherence amplitude is computed over the window specified in the input parameters based on a specified horizon. In step 820, the previous steps are repeated at each imaging location and for each depth. In step 824, the coherency amplitudes of the gathers are plotted. In step 828, the gather having the maximum coherence amplitude over the analysis window is selected as the optimum gather. In step 832, the azimuth parameters associated with the optimum gather are chosen as the optimum set of azimuth parameters.

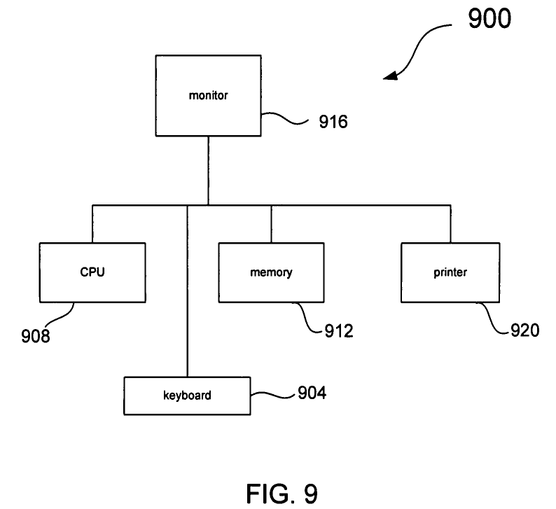

FIG. 9 shows an exemplary computer system 900 configured to execute the seismic data processing steps described above. The computer system 900 includes a key board 904, a CPU 908, a memory device 912, a monitor 916 and a printer 920. The computer system 900 runs a computer program code configured to carry out the seismic data processing steps described above. The computer program code may reside in the memory device 912 and may be executed by the CPU 908. The results may be displayed on the monitor or printed at the printer 920.

In one embodiment, a computer program product includes a computer usable medium having computer readable program code embodied in the medium for determining optimum azimuth parameters for seismic data processing. The computer program product may be a CD-ROM, an optical disk, a hard-drive or any other storage device. The computer readable program code includes a first computer readable program code for generating a plurality of seismic gathers from azimuth parameters, each pair of azimuth parameters indicating a magnitude and a direction, wherein each seismic gather is generated from a pair of azimuth parameters, each seismic gather including a plurality of seismic data traces. The computer readable program code includes a second computer readable program code for generating a plurality of seismic gathers for a plurality of imaging locations and a plurality of depths, each seismic gather containing a plurality of seismic data traces. The computer readable program code includes a third computer readable program code for determining the coherence amplitude of each gather. The computer readable program code includes a fourth computer readable program code for determining the gather having the optimum coherence amplitude, and selecting the azimuth parameters associated with the gather having the optimum coherence amplitude.

While the methods, structures, and systems of this invention have been described in terms of preferred embodiments, it will be apparent to those skilled in the art that variations may be applied to the methods, structures and systems and in the steps or in the sequence of steps of the methods described herein without departing from the concept of the invention. All such substitutes and modifications apparent to those skilled in the art are deemed to be within the spirit, scope and concept of the invention as defined by the appended claims.

What is claimed is:

1. A method for determining optimum azimuth parameters for seismic data processing, comprising:
selecting a range of azimuth parameters, the azimuth parameters indicating the range of magnitudes and directions, each pair of azimuth parameters indicating a magnitude and a direction;
generating a plurality of seismic gathers wherein a seismic gather is generated for each pair of azimuth parameters, each seismic gather including a plurality of seismic data traces;
generating a plurality of seismic gathers for a plurality of imaging locations and a plurality of depths, each seismic gather containing a plurality of seismic data traces;
determining the coherence amplitude of each gather; and
determining the gather having the optimum coherence amplitude, and selecting the azimuth parameters associated with the gather having the optimum coherence amplitude.

2. The method according to claim 1, wherein the coherence amplitude of each gather is determined by combining a plurality of seismic data traces in the gather.

3. The method according to claim 1, wherein the optimum coherence amplitude is determined by determining the highest coherence amplitude and designating the highest coherence amplitude as the optimum coherence amplitude.

4. The method according to claim 1, wherein the optimum coherence amplitude is determined by determining the gather having the maximum coherence amplitude over a threshold value, and designating the maximum coherence amplitude over the threshold value as the optimum coherence amplitude.

5. The method according to claim 1, further comprising:
plotting the coherence amplitude of the gathers;
identifying the optimum gather by determining the gather having the maximum coherence amplitude over an analysis window; and
selecting the azimuth parameters associated with the optimum gather and identifying the selected azimuth parameters as the optimum azimuth parameters.

6. The method according to claim 1, wherein the seismic data trace is generated by transmitting seismic signals into the Earth's subsurface and detecting the reflected signals.

7. The method according to claim 6, wherein the seismic signals are transmitted by seismic sources and the reflected signals are detected by seismic receivers.

8. The method according to claim 1, wherein each seismic data trace in a gather is generated from a different seismic source-seismic receiver pair.

9. The method according to claim 1, wherein a single gather includes a collection of seismic data traces computed at a single location.

10. A computer program product comprising a computer usable medium having computer readable program code embodied in the medium for determining optimum azimuth parameters for seismic data processing, comprising:
a first computer readable program code for generating a plurality of seismic gathers from azimuth parameters, each pair of azimuth parameters indicating a magnitude and a direction, wherein each seismic gather is generated from a pair of azimuth parameters, each seismic gather including a plurality of seismic data traces;
a second computer readable program code for generating a plurality of seismic gathers for a plurality of imaging locations and a plurality of depths, each seismic gather containing a plurality of seismic data traces;
a third computer readable program code for determining the coherence amplitude of each gather; and
a fourth computer readable program code for determining the gather having the optimum coherence amplitude, and selecting the azimuth parameters associated with the gather having the optimum coherence amplitude.

11. The computer program product of claim 10, wherein the coherence amplitude of each gather is determined by combining a plurality of seismic data traces in the gather.

12. The computer program product of claim 10, wherein the optimum coherence amplitude is determined by determining the highest coherence amplitude and designating the highest coherence amplitude as the optimum coherence amplitude.

13. The computer program product of claim 10, wherein the optimum coherence amplitude is determined by determining the gather having the maximum coherence amplitude over a threshold value, and designating the maximum coherence amplitude over the threshold value as the optimum coherence amplitude.

14. The computer program product of 10, further comprising:
a fifth computer readable program code for plotting the coherence amplitude of the gathers;
a sixth computer readable program code for identifying the optimum gather by determining the gather having the maximum coherence amplitude over an analysis window; and
a seventh computer readable program code for selecting the azimuth parameters associated with the optimum gather and identifying the selected azimuth parameters as the optimum azimuth parameters.

15. A computer-implemented method for determining optimum azimuth parameters for seismic data processing, comprising:
selecting a range of azimuth parameters, the azimuth parameters indicating the range of magnitudes and directions, each pair of azimuth parameters indicating a magnitude and a direction;
generating a plurality of seismic gathers wherein a seismic gather is generated from each pair of azimuth parameters, each seismic gather including a plurality of seismic data traces;
generating a plurality of seismic gathers for a plurality of imaging locations and a plurality of depths, each seismic gather containing a plurality of seismic data traces;
determining the coherence amplitude of each gather; and
determining the gather having the optimum coherence amplitude, and selecting the azimuth parameters associated with the gather having the optimum coherence amplitude.

16. The computer-implemented method according to claim 15, wherein the coherence amplitude of each gather is determined by combining a plurality of seismic data traces in the gather.

17. The computer-implemented method according to claim 15, wherein the optimum coherence amplitude is determined by determining the highest coherence amplitude and designating the highest coherence amplitude as the optimum coherence amplitude.

18. The computer-implemented method according to claim 15, wherein the optimum coherence amplitude is determined by determining the gather having the maximum coherence amplitude over a threshold value, and designating the maximum coherence amplitude over the threshold value as the optimum coherence amplitude.

19. The computer-implemented method according to claim 15, further comprising:
plotting the coherence amplitude of the gathers;
identifying the optimum gather by determining the gather having the maximum coherence amplitude over an analysis window; and
selecting the azimuth parameters associated with the optimum gather and identifying the selected azimuth parameters as the optimum azimuth parameters.

20. The computer-implemented method according to claim 15, wherein the seismic data trace is generated by transmitting seismic signals into the Earth's subsurface and detecting the reflected signals.
